(19) United States
(12) Patent Application Publication
(10) Pub. No.: US 2022/0221298 A1
(43) Pub. Date: Jul. 14, 2022

(54) VEHICLE CONTROL SYSTEM AND VEHICLE CONTROL METHOD

(71) Applicant: HONDA MOTOR CO., LTD., Tokyo (JP)

(72) Inventors: Hidetoshi CHIKAMORI, Saitama (JP); Kazumasa NAKAMURA, Saitama (JP); Hitoshi KONISHI, Saitama (JP); Takuji HARAYAMA, Saitama (JP); Tomoaki MASAKAWA, Tokyo (JP); Naofumi ASO, Saitama (JP); Ryo MATSUZAWA, Tokyo (JP); Zhaoqi WANG, Tokyo (JP)

(21) Appl. No.: 17/573,114

(22) Filed: Jan. 11, 2022

(30) Foreign Application Priority Data
Jan. 12, 2021 (JP) 2021-002653

(51) Int. Cl. G01C 21/36; G01C 21/34

(52) U.S. Cl. CPC G01C 21/3658; G01C 21/367; G01C 21/362; G01C 21/3469

(57) ABSTRACT

Provided is a system for generating a recommended driving lane based on a general-purpose map with improved real-time property for updating. A vehicle control system 1 for controlling a vehicle 2 during autonomous driving thereof, comprises a vehicle control unit 3 and a mobile terminal 5. The vehicle control unit 3 acquires travel control map data from a first map server 4 and transmits position data of the vehicle 2 to the mobile terminal 5. The mobile terminal 5 acquires navigation map data containing lane information on lanes forming each road section from a second map server 6, generates, based on the lane information and the position data of the vehicle 2, driving route information including a recommended driving lane which should be selected on a priority basis as a driving lane for the vehicle, and transmits the driving route information to the vehicle control unit 3.

### TECHNICAL FIELD

The present invention relates to a vehicle control system and a vehicle control method for controlling a vehicle based on map information during autonomous driving of the vehicle.

### BACKGROUND ART

Generally, a known in-vehicle navigation device is configured to identify the current position of a vehicle in the built-in map data based on the position coordinates of the vehicle acquired from a GNSS (global navigation satellite system) or any other positioning system. In addition, such as an in-vehicle navigation device is configured to search for a driving route from the current position of a vehicle to a destination specified by a user, and display the searched driving route overlaid on a map screen on the display.

In the case of stand-alone in-vehicle navigation devices, built-in map data in a navigation device needs to be updated by a vehicle dealer or a maintenance service company, which results in problems of the difficulty in updating map data frequently (e.g., on a real time basis), and higher operating costs related to updating the map.

A known navigation device, which has been proposed to address such problems, is configured to receive the latest map data on a real time basis from a mobile terminal communicably connected thereto for the purpose of improving the efficiency and real-time property for updating the map (see Patent Document 1).

In recent years, some known vehicle control systems for autonomous driving are configured such that a general-purpose map is in an in-vehicle navigation device and used for navigation, while a high-precision map containing more detailed information than the general-purpose map is acquired from a map server or any other station for travel control of a vehicle (see Patent Document 2).

### PRIOR ART DOCUMENT (S)

### Patent Document(s)

Patent Document 1: JP2016-105080A
Patent Document 2: JP2006-266865A

### SUMMARY OF THE INVENTION

### Task to be Accomplished by the Invention

In the prior art disclosed in Patent Document 2, the general-purpose built-in map in the in-vehicle navigation device is inferior in the real-time property for updating to a high-precision map acquired from a map server or other external stations. As a general-purpose built-in map does not include information on lanes forming each road section, a driving route determined by using the general-purpose map does not include information on driving lanes.

In the prior art disclosed in Patent Document 1, the system can acquire the latest general-purpose map data on a real-time basis from a mobile terminal. However, the general-purpose map does not include information on lanes forming each road section, either.

In other words, the prior art disclosed in either of Patent Documents 1 and 2 does not consider determining, based on general-purpose map data, a driving route including information about a driving lane(s) which should be selected on a priority basis as a driving lane for the vehicle. As a result, these prior art systems need to coordinate driving route information generated based on general-purpose map data and containing no lane information with a high-precision map including lane information, resulting in that a high processing load is imposed on the systems during the operation for coordinating two types of map data.

The present invention has been made in view of the problem of the prior art, and a primary object of the present invention is to provide a vehicle control system and a vehicle control method for controlling a vehicle, which can generate a recommended driving lane which should be selected on a priority basis as a driving lane for the vehicle based on a general-purpose map with improved real-time property for updating (i.e., a general-purpose map that can be updated in more real time, or substantially on a real time basis).

### Means to Accomplish the Task

An aspect of the present invention provides a vehicle control method for controlling a vehicle based on map information during autonomous driving of the vehicle, the method being performed by a vehicle control system, wherein the vehicle control system comprises: a vehicle control unit mounted in the vehicle, wherein the vehicle control unit is configured to acquire travel control map data from a first map server, the travel control map data being data of a travel control map used for travel control, and perform the travel control of the vehicle based on the travel control map; and a mobile terminal communicatively connected to the vehicle control unit, wherein the mobile terminal is configured to acquire navigation map data from a second map server, the navigation map data being data of a navigation map for route navigation, and provide the vehicle control unit with driving route information on a driving route in the navigation map, wherein the navigation map contains lane information on a lane(s) forming each road section, wherein the vehicle control unit is configured to transmit position data of the vehicle to the mobile terminal, and wherein the mobile terminal is configured to: based on the lane information and the position data of the vehicle received from the vehicle control unit, generate the driving route information including recommended lane information about a recommended driving lane which should be selected on a priority basis as a driving lane for the vehicle; and transmit the driving route information including the recommended lane information to vehicle control unit.

In this configuration, map data of a navigation map (i.e., general-purpose map) is acquired from a map server, which enables generation of a recommended driving lane which should be selected on a priority basis as a driving lane for the vehicle based on the general-purpose map with improved real-time property for updating.

In the above aspect, the mobile terminal is preferably configured to: sequentially receive the multiple position data of the traveling vehicle from the vehicle control unit; update the driving route information including the recommended lane information based on the latest position data of the vehicle; and transmit the updated driving route information to the vehicle control unit.

This configuration enables determination of a more appropriate driving route according to the latest position of the vehicle.

In the above aspects, the travel control map data preferably includes dynamically changeable information which is not included in the navigation map data and can change with time in a more dynamic manner than that included in the navigation map data, and wherein the dynamically changeable information includes at least one type of information selected from signal information, nearby vehicle information, and pedestrian information.

This configuration enables effective utilization of the navigation map (that is, a general-purpose map) with a relatively small amount of information (i.e., amount of data) and a travel control map with a relatively large amount of information (that is, a high-precision map) for route navigation and travel control, respectively.

In the above aspects, the vehicle control unit is preferably configured to request the first map server to transmit the travel control map data based on the driving route information including the recommended lane information.

This configuration enables efficient acquisition of the travel control map data for a necessary area based on the driving route information including the recommended lane information about a recommended driving lane which should be selected on a priority basis as a driving lane for the vehicle.

In the above aspects, the mobile terminal is preferably configured to calculate an estimated arrival time when the vehicle will arrive at an end point of the driving route based on the driving route information including the recommended lane information, and transmit the estimated arrival time to the vehicle control unit.

This configuration enables the vehicle control unit to easily acquire the estimated arrival time from the mobile terminal to the end point (that is, the destination) of the driving route. In this case, the mobile terminal calculates the estimated arrival time based on the driving route information including the recommended lane information, which improves the accuracy of the calculated value.

In the above aspects, the mobile terminal is preferably configured to acquire sensor measurement data from the vehicle control unit, the sensor measurement data being acquired by a sensor for measuring a remaining amount of battery or fuel used for driving of the vehicle, and determine the driving route based on the sensor measurement data.

This configuration enables determination of a more appropriate driving route according to the remaining amount of battery or fuel used for driving of the vehicle.

Another aspect of the present invention provides a vehicle control system for controlling a vehicle based on map information during autonomous driving of the vehicle, the system comprising: a vehicle control unit mounted in the vehicle, wherein the vehicle control unit is configured to acquire travel control map data from a first map server, the travel control map data being data of a travel control map used for travel control, and perform the travel control of the vehicle based on the travel control map; and a mobile terminal communicatively connected to the vehicle control unit, wherein the mobile terminal is configured to acquire navigation map data from a second map server, the navigation map data being data of a navigation map for route navigation, and provide the vehicle control unit with driving route information on a driving route in the navigation map, wherein the navigation map contains lane information on a lane(s) forming each road section, wherein the vehicle control unit is configured to transmit position data of the vehicle to the mobile terminal, and wherein the mobile terminal is configured to: based on the road information and the position data of the vehicle received from the vehicle control unit, generate the driving route information including recommended lane information about a recommended driving lane which should be selected on a priority basis as a driving lane for the vehicle; and transmit the driving route information including the recommended lane information to vehicle control unit.

In this configuration, map data of a navigation map (i.e., general-purpose map) is acquired from a map server, which enables generation of a recommended driving lane which should be selected on a priority basis as a driving lane for the vehicle based on the general-purpose map with improved real-time property for updating.

### Effect of the Invention

As described above, the present invention can provide a vehicle control system and a vehicle control method for controlling a vehicle, which can generate a recommended driving lane which should be selected on a priority basis as a driving lane for the vehicle based on a general-purpose map with improved real-time property for updating.

### BRIEF DESCRIPTION OF THE DRAWINGS

FIG. 1 is a functional block diagram showing a configuration of a vehicle control system according to one embodiment of the present invention;

FIG. 2 is a functional block diagram showing a configuration of a mobile terminal;

FIG. 3 is a time chart showing operations of the vehicle control system during autonomous driving of a vehicle; and

FIG. 4 is a flow chart showing an operation procedure of a route generation operation performed by the mobile terminal.

### DESCRIPTION OF THE PREFERRED EMBODIMENT(S)

Hereinafter, embodiments of a vehicle control system and a vehicle control method for controlling a vehicle according to the present invention are described in the following with reference to the appended drawings.

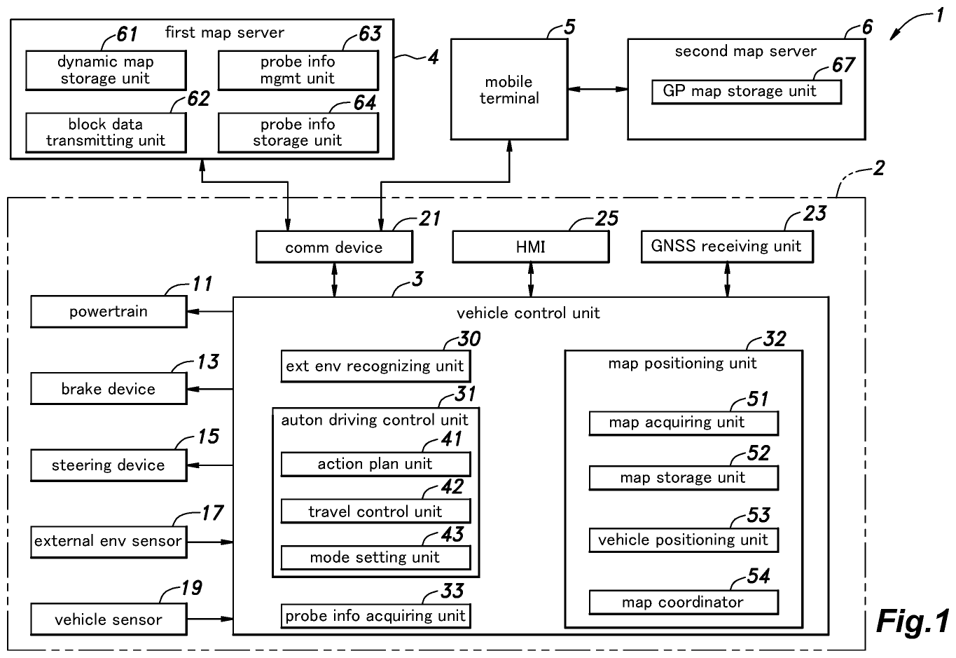

As shown in FIG. 1, a vehicle control system 1 mainly includes: a vehicle control unit 3 mounted in a vehicle 2; a first map server 4 communicably connected to the vehicle control unit 3, and configured to provide the vehicle control unit 3 with travel control map data, which is data of a travel control map used for travel control; a mobile terminal 5 communicably connected to the vehicle control unit 3, and configured to provide the vehicle control unit 3 with driving route information on a driving route of the vehicle 2; and a second map server 6 configured to provide the mobile terminal 5 with navigation map data, which is data of a navigation map for route navigation for the vehicle 2.

The vehicle 2 can perform autonomous driving (automated driving) by the vehicle control system 1 without requiring a driver's driving operation. In addition to the vehicle control unit 3, the vehicle 2 includes a powertrain 11, a brake device 13, a steering device 15, an external environment sensor 17, a vehicle sensor 19, a communication device 21, a GNSS receiving unit 23, and an HMI (human-machine interface) 25. These devices and elements are connected to each other so that they can transmit and receive signals to and from each other through a communication network such as CAN (Control Area Network) (not shown). At least some of these devices and elements can constitute part of the vehicle control system 1.

The powertrain 11 is a known apparatus for providing a driving force to the vehicle 2 and is provided with at least one of an internal combustion engine (such as a gasoline engine and a diesel engine) and an electric motor. Furthermore, the powertrain 11 is provided with a fuel tank for an internal combustion engine and/or a battery for an electric motor as necessary. The brake device 13 is a known apparatus for providing a braking force to the vehicle 2. The steering device 15 is a known apparatus for changing the steering angle of the wheels. The powertrain 11, the brake device 13, and the steering device 15 are controlled by the vehicle control unit 3.

The external environment sensor 17 is a sensor for detecting an object outside the vehicle by capturing electromagnetic waves or sound waves reflected from the object located around the vehicle 2. The external environment sensor 17 may include one or more sensors having a known configuration, such as a sonar, an external camera (e.g., a camera for recording the front view of the vehicle 2), a millimeter wave radar, and a laser rider. A detection result by the external environment sensor 17 is supplied to the vehicle control unit 3.

The vehicle sensor 19 is a sensor for measuring a state of the vehicle 2. The vehicle sensor 19 includes one or more sensors such as a vehicle speed sensor for detecting the speed of vehicle 2, an accelerometer for detecting the acceleration of vehicle 2; a gyro sensor for detecting the angular velocity around the vertical axis of vehicle 2; a directional sensor for detecting the orientation of vehicle 2; a tilt sensor for detecting the tilt of the vehicle body; and a wheel speed sensor for detecting the rotational speed of a wheel. Furthermore, the vehicle sensor 19 may also include a sensor for detecting the remaining amount of fuel in the fuel tank for the internal combustion engine and a sensor for detecting the remaining amount of the battery for the electric motor.

The communication device 21 includes a communication circuit and an antenna for wirelessly communicating with external apparatuses (for example, a data processing device such as the mobile terminal 5 or the first map server 4) according to a known standard communication method. The communication device 21 may also perform wired communications with external apparatuses via a known communication cable. The communication device 21 includes a router that connects the vehicle control unit 3 to a network such as the Internet. The communication device 21 can transmit and receive various data to and from external apparatuses by connecting to the external apparatuses via a nearby base station or access point. The communication device 21 may be composed primarily of multiple communication devices that each can communicate with external apparatuses.

The GNSS receiving unit 23 receives signals (hereinafter, referred to as “GNSS signals”) from a plurality of satellites constituting the Global Navigation Satellite System (GNSS). The GNSS receiving unit 23 provides the received GNSS signal to the vehicle control unit 3.

The vehicle 2 is provided with known operation input members such as a steering wheel, an accelerator pedal, a brake pedal, a shift lever, a parking brake lever, and a winker lever, as needed. Furthermore, the vehicle 2 is provided with known sensors for driving such as a steering angle sensor for detecting the amount of operation of the steering wheel, an accelerator sensor for detecting the amount of operation of the accelerator pedal, and a brake sensor for detecting the amount of operation of the brake pedal, as needed.

The HMI 25 notifies an occupant(s) of the vehicle 2 (usually including a user of the mobile terminal 5) of various pieces of information by visual indication or voice, and receives input operations performed by the occupant(s). The HMI 25 may be, for example, a liquid crystal display and an organic EL, and includes a touch panel for receiving input operations performed by an occupant, and a sound generator such as a buzzer and a speaker.

The HMI 25 also functions as an interface for input/output to and from the mobile terminal 5. Specifically, when the HMI 25 receives a destination input operation performed by the occupant, the mobile terminal 5 starts to generate a route to the destination entered by the occupant. In addition, when providing the occupant with guidance about the route, the HMI 25 can display the current position of the vehicle 2 and the route to the destination generated by the mobile terminal 5.

Next, the vehicle control unit 3 will be described. The vehicle control unit 3 is composed primarily of one or more electronic control units (ECUs) including a processor such as a CPU, a ROM, and a RAM. In the vehicle control unit 3, the processor executes processing operations according to programs thereby performing various vehicle controls. The vehicle control unit 3 may be configured as one piece of hardware, or may be configured as a unit composed of multiple pieces of hardware. At least a part of each functional unit of the vehicle control unit 3 may be implemented by hardware such as LSI, ASIC, FPGA, or by a combination of software and hardware.

As shown in FIG. 1, the vehicle control unit 3 includes an external environment recognizing unit 30, an autonomous driving control unit 31 (Advanced Driver-Assistance Systems: ADAS), a map positioning unit 32 (Map Positioning Unit: MPU), and a probe information acquiring unit 33. These components may be configured by separate electronic control devices, respectively, and may be connected to each other via a gateway (central gateway, CGW). Alternatively, these components may be configured by an integral electronic control device.

The external environment recognizing unit 30 recognizes a target object(s) located around the vehicle based on the detection result of the external environment sensor 17, and acquires information on the position and size of the target object(s). Target objects to be recognized by the external environment recognizing unit 30 includes a lane marking, a lane, a road side end, a road shoulder, and an obstacle provided on the road on which the vehicle is traveling.

A lane marking is a partitioning line extending along the vehicle traveling direction. A lane is an area partitioned by one or more lane markings. A road side end is an end of the road in the width direction. A road shoulder is the area between a road side end and the outermost lane marking in the width direction. Obstacles include, for example, barriers (guardrails), utility poles, nearby vehicles, pedestrians, and other nearby objects.

The external environment recognizing unit 30 analyzes images captured by t the external camera to recognize the relative position of a target object(s) located around the vehicle 2. For example, the external environment recognizing unit 30 can use a known method such as triangulation method or motion stereo method to thereby recognize the distance and the direction from the vehicle 2 to the target object when viewed from directly above, with respect to the vehicle body. Furthermore, the external environment recognizing unit 30 analyzes images captured by the external camera to determine the type of each target object (e.g., lane marking, lane, roadside end, road shoulder, obstacle) by using a known recognition scheme.

The autonomous driving control unit 31 includes an action plan unit 41, a travel control unit 42, and a mode setting unit 43.

The action plan unit 41 creates an action plan for controlling the traveling of the vehicle 2. The action plan unit 41 provides travel control signals corresponding to the created action plan to the travel control unit 42.

The travel control unit 42 controls the powertrain 11, the brake device 13, and the steering device 15 based on the travel control signals from the action plan unit 41. In other words, the travel control unit 42 drives the vehicle 2 according to the action plan created by the action plan unit 41.

The mode setting unit 43 switches a driving mode of the vehicle 2 between a manual driving mode and an autonomous driving mode in response to the occupant's input to the HMI 25. In the manual operation mode, the travel control unit 42 controls the powertrain 11, the brake device 13, and the steering device 15 in response to the occupant's operations on operation input members (e.g., the steering wheel, accelerator pedal and/or brake pedal) to thereby drive the vehicle 2. In the autonomous driving mode, the occupant does not need to operate the operation input members, and the travel control unit 42 controls the powertrain 11, the brake device 13, and the steering device 15 to thereby autonomously drive the vehicle 2. In other words, the automation level when driving in the autonomous driving mode is higher than that in the manual operation mode.

The map positioning unit 32 includes a map acquiring unit 51, a map storage unit 52, a vehicle positioning unit 53, and a map coordination unit 54.

The map acquiring unit 51 accesses the first map server 4 to acquire dynamic map data (i.e., data of a dynamic map) including highly accurate map information from the first map server 4. The dynamic map is used as a map for travel control. For example, the map acquiring unit 51 may acquire from the first map server 4 the latest dynamic map data of an area corresponding to the route generated by the mobile terminal 5. Map data acquired by the map acquiring unit 51 is not limited to the dynamic map data, and may be different map data having at least higher accuracy than the navigation map data.

The dynamic map data, which is more detailed map data than the navigation map data used to generate a route, includes static information, quasi-static information, quasi-dynamic information, and dynamic information. The static information includes three-dimensional map data that is more accurate than the navigation map data. The quasi-static information includes traffic regulation information, road construction information, and wide area meteorological information that are more detailed than the navigation map data. The semi-dynamic information includes accident information, congestion information, and narrow area weather information that are more detailed than the navigation map data. The dynamic information includes dynamically changeable information which can change with time in a more dynamic manner than the static information, such as signal information, surrounding vehicle information, and pedestrian information that are not included in the navigation map data. The signal information includes information about traffic lights located in the route (for example, timing of traffic light changing). The surrounding vehicle information includes information on other vehicles located near the vehicle 2 (for example, position, moving direction, speed of each nearby vehicle). The pedestrian information includes information about pedestrians located around the vehicle 2 (for example, position, moving direction, person attribute of each nearby pedestrian). It should be noted that all of the static information, the quasi-static information, the quasi-dynamic information, and the dynamic information do not need to be used as travel control map data for the vehicle 2, and map data including at least the static information as high-precision map data can serve as the travel control map data.

The static information in the dynamic map data includes information on lanes of each road section in the travel path (for example, the number of lanes) and information on the lane markings on the road on which the vehicle is traveling (such as the type of lane markings). For example, information on a lane marking in the static information is represented by a plurality of nodes arranged at intervals shorter than the nodes in the navigation map, and links connecting pairs of adjacent nodes.

In addition, the roadway (including each road section) in static information is also represented by a plurality of nodes arranged at predetermined intervals and links connecting pairs of adjacent nodes (hereinafter referred to as roadway links). Roadway nodes are created between a sequence of lane marking nodes on the left edge of the road and those on the right edge of the road. Roadway link nodes are provided at predetermined intervals along the road.

The static information further includes information on road shoulder edges. A road shoulder edge is the side edge of the road on which the vehicle travels, and when a sidewalk is provided along a road, a road shoulder edge can be the boundary between the road and the sidewalk. A load shoulder edge in the static information is represented by a plurality of nodes arranged along the load shoulder edge at approximately the same intervals as the lane marking nodes, and links connecting pairs of adjacent nodes.

The map storage unit 52 includes a storage device such as an HDD or SSD, and stores various information necessary for autonomous driving of a vehicle in the autonomous driving mode. The map storage unit 52 stores the dynamic map data acquired from the first map server 4 by the map acquiring unit 51.

The vehicle positioning unit 53 identifies the position (latitude, longitude) of the vehicle 2, which is the position of the own vehicle, based on GNSS signals provided from the GNSS receiving unit. The vehicle positioning unit 53 transmits vehicle position information (the position data of the vehicle 2) to the mobile terminal 5.

Furthermore, the vehicle positioning unit 53 uses the detection result of the vehicle sensor (such as IMU) to determine the movement amount of the vehicle 2 (the movement distance and the movement direction of the vehicle, hereinafter referred to as “DR movement amount”) through dead reckoning (such as odometry). The vehicle positioning unit 53 can identify the position of the own vehicle based on the DR movement amount, for example, when GNSS signals cannot be received. In the present embodiment, the vehicle positioning unit 53 uses the DR movement amount to correct the vehicle position determined based on the GNSS signals, thereby improving the accuracy of positioning of the vehicle.

The position of the own vehicle identified by the vehicle control unit 3 is more accurate than that can be acquired by the mobile terminal 5 by using the same function as the GNSS receiving unit 23 (for example, the GPS function). Thus, by acquiring the position data of the vehicle identified by the vehicle 2, the mobile terminal 5 can use the position of the vehicle 2 with higher accuracy than that estimated from the position of the mobile terminal 5 itself which has been brought into the vehicle 2. Furthermore, the mobile terminal 5 can advantageously acquire the position data of the vehicle 2 even when a user of the mobile terminal 5 is not present in the vehicle 2 (that is, when the mobile terminal 5 is not brought into the vehicle).

The map coordination unit 54 extracts, based on the route information received from the mobile terminal 5, a corresponding route in the high-precision map (static information) stored in the map storage unit 52.

When the vehicle 2 is instructed to start autonomous driving, the action plan unit 41 plans a global action plan (including changing lanes, following a road merging with another one, selecting a road at the fork in the road, for example) based on the information on a route in the high-precision map extracted by the map coordination unit 54. The action plan unit 41 may uses the information on a route in the navigation map received from the mobile terminal 5 as a basis for a global action plan. After that planning operation, when the vehicle 2 starts autonomous driving, the action plan unit 41 creates a more detailed action plan (including avoiding dangerous actions, for example) based on the global action plan, the position of the vehicle identified by the vehicle positioning unit 53, the object recognized by the external environment recognizing unit 30, the high-precision map stored in the map storage unit 52, and other information, and then based on the created plan, the travel control unit 42 controls the driving of the vehicle.

The probe information acquiring unit 33 associates the position of the vehicle identified by the vehicle positioning unit 53 based on GNSS signals, with data detected by at least one of the sensors including the external environment sensor 17, the vehicle sensor 19, and driving operation sensors (such as the steering angle sensor, accelerator sensor, brake sensor), to thereby acquire and stores the associated data set as probe information. The probe information acquiring unit 33 also acquires and stores surrounding information acquired by the external environment sensor 17 (such as a video image of the front view of the vehicle acquired by the external camera). The probe information acquiring unit 33 transmits the acquired probe information to the first map server 4 as appropriate. The probe information acquiring unit 33 can also transmit the probe information to the mobile terminal 5 as necessary.

(First Map Server)

Next, the first map server 4 will be described. As shown in FIG. 1, the first map server 4 is connected to the vehicle control unit 3 via a network (the Internet in the present embodiment). The first map server 4 is a computer including a processor such as a CPU, a ROM, a RAM, and a storage device such as an HDD or an SSD.

The storage device of the first map server 4 stores dynamic map data. The dynamic map data stored in the first map server 4 is map data of a wider area than the dynamic map data stored in the map storage unit 52 of the vehicle control unit 3. In other words, the dynamic map data required to be stored in the map storage unit 52 of the vehicle control unit 3 is only partial map data required for a route of the vehicle 2. The dynamic map data of the first map server 4 includes a plurality of block data (partial map data) corresponding to each area on the map. Preferably, each block data is map data corresponding to a rectangular area on the map defined by two sets of boundaries extending in the latitude direction and the longitude direction.

Upon receiving a data request from the vehicle control unit 3 (the map acquiring unit 51) via the communication device 21, the first map server 4 transmits a dynamic map corresponding to the requested data to the vehicle control unit 3. The transmitted data may include congestion information and weather information.

As shown in FIG. 1, the first map server 4 includes a dynamic map storage unit 61, a block data transmitting unit 62, a probe information management unit 63, and a probe information storage unit 64.

The dynamic map storage unit 61 is configured by a storage device and stores a dynamic map which covers an area in which the vehicle 2 can travel. The block data transmitting unit 62 receives a transmission request for specific block data from the vehicle 2, and transmits the block data corresponding to the transmission request to the vehicle.

The probe information storage unit 64 stores and maintains probe information acquired by a probe information receiving unit. Based on the probe information stored in the probe information storage unit 64, the probe information management unit 63 performs statistical processing operations as appropriate and performs update operations for updating the dynamic map data. In other embodiments, the vehicle 2 may transmits probe information as appropriate to the mobile terminal 5, so that the probe information management unit 63 can receive the probe information from the vehicle 2 via the mobile terminal 5. This configuration can reduce the processing load imposed on the communication device 21, which performs wireless communications.

(Mobile Terminal)

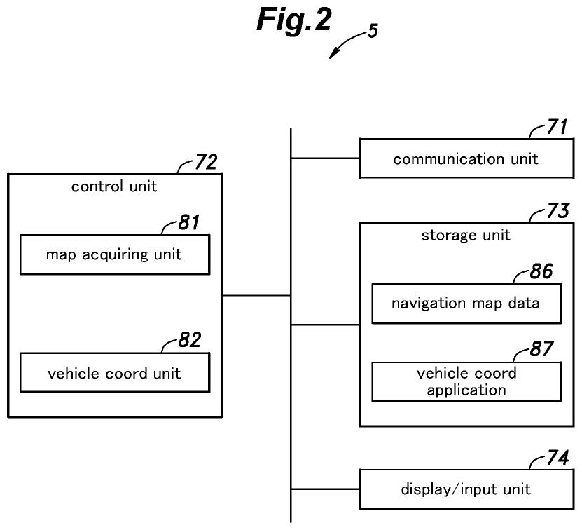

The mobile terminal 5 is a data processing device having a known hardware configuration such as a smartphone, a tablet PC, and a notebook PC carried by a user of the vehicle 2. As shown in FIG. 2, the mobile terminal 5 includes a communication unit 71, a control unit 72, a storage unit 73, and a display/input unit 74.

The communication unit 71 has a communication circuit and an antenna for performing wireless communications according to a known standard communication method. The communication unit 71 transmits/receives data to and from the vehicle control unit 3 by directly performing wireless communications with the communication device 21 of the vehicle 2 or by performing indirect communications with the communication device 21 via the Internet or any other network. The communication unit 71 can also be connected to the communication device 21 via a known communication cable so that it can perform wired communications with the communication device 21. The communication unit 71 is communicably connected to the second map server 6 via the Internet or any other network.

The control unit 72 includes a map acquiring unit 81 and a vehicle coordination unit 82.

The map acquiring unit 81 acquires navigation map data 86 from the second map server 6. The navigation map data 86 acquired by the map acquiring unit 81 is stored in the storage unit 73. The navigation map data is map data of a wide area including at least data of an area from which a route of the vehicle 2 can be determined. In other embodiments, the map acquiring unit 81 may acquire in advance map data corresponding to all areas in which the vehicle 2 can travel from the second map server 6.

The vehicle coordination unit 82 coordinates with the vehicle control unit 3 of the vehicle 2 to perform operations for assisting autonomous driving of the vehicle 2. In particular, the vehicle coordination unit 82 provides the vehicle control unit 3 with map data including information on a route of the vehicle 2.

The control unit 72 includes a processor such as a CPU, a ROM, and a RAM. Each functional unit of the control unit 72 such as the map acquiring unit 81 and the vehicle coordination unit 82 can be implemented by the processor performing processing operations according to programs.

The storage unit 73 includes a storage device such as an HDD or SSD. The storage unit 73 stores a vehicle coordination application 87, which is a program for coordinating operations with the vehicle control unit 3. The control unit 72 can perform the coordinating operations using the vehicle coordination application 87 to thereby generate route information on a route of the vehicle 2 and provide the route information to the vehicle 2.

The display/input unit 74 includes a touch panel display. The display/input unit 74 displays various information for a user. The user can enter various settings and operation instructions for the mobile terminal 5 via the display/input unit 74.

(Second Map Server)

As shown in FIG. 1, the second map server 6 is connected to the mobile terminal 5 via a network (the Internet in the present embodiment). The second map server 6 is a computer including a processor such as a CPU, a ROM, a RAM, and a storage device such as an HDD or an SSD.

A general-purpose map storage unit 67 of the second map server 6 stores navigation map data, which is data of a navigation map. The navigation map is a general-purpose map such as a Google map or an Apple map. Although, in the present embodiment, the second map server 6 is shown as a component of the vehicle control system 1, the second map server 6 does not need to be provided exclusively for the vehicle control system 1, and may be a shared map server, which is managed independently from the vehicle control system 1. The same applies to the first map server 4 described above.

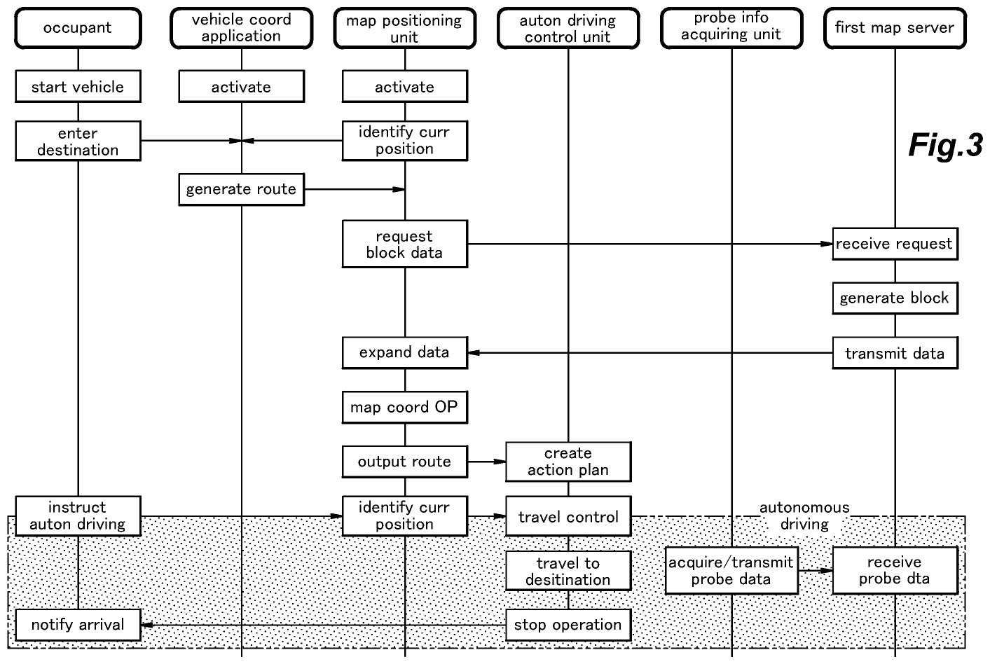

Next, operations of the vehicle control system 1 will be described with reference to FIG. 3. FIG. 3 is a time chart showing operations of the vehicle control system from when a vehicle 2 starts to move until the vehicle reaches the destination.

When an occupant gets into the vehicle 2 and starts the vehicle 2, the vehicle control unit 3 (including the autonomous driving control unit 31 and the map positioning unit 32) and other devices and equipment mounted in the vehicle 2 start their operations The map positioning unit 32 starts identifying the position of a vehicle (the position of the vehicle 2) based on the GNSS signals from the satellites and the DR movement amount. The acquired position data of the vehicle 2 is sequentially transmitted to the mobile terminal 5.

A user of the mobile terminal 5 (the occupant in this case) operates the mobile terminal 5 to activate the vehicle coordination application 87. In other cases, the vehicle coordination application 87 may be automatically activated when the mobile terminal 5 starts performing wireless communications with the vehicle control unit 3 without any user's operation.

Subsequently, when the user operates the mobile terminal 5 to enter a destination, the mobile terminal 5 performs a route generation operation for generating a route from the current position of the vehicle 2 to the destination based on navigation map data. The current position of the vehicle 2 is based on the latest position data of the vehicle 2 received from the vehicle control unit 3. The user may enter a destination using the HMI 25. In this case, the mobile terminal 5 can acquire the destination information input through the HMI 25 from the vehicle control unit 3.

The mobile terminal 5 performs the route generation operation for generating a route based on the acquired current position data and destination information of the vehicle 2. The mobile terminal 5 transmits the generated route information on a driving route of the vehicle to the vehicle control unit 3 (the map positioning unit 32). The route information is formed based on the navigation map data. As will be described in detail later, the route searched by the mobile terminal 5 includes lane information on a lane which should be selected on a priority basis as a driving lane for the vehicle (hereinafter, referred to as a recommended driving lane).

When receiving the route information from the mobile terminal 5, the map positioning unit 32 requests the first map server 4 to transmit block data of a dynamic map corresponding to the route.

Upon receiving the request from the map positioning unit 32, the first map server 4 generates the corresponding block data based on the route determined by the mobile terminal 5 and the current position of vehicle 2, and transmits the generated block data to the vehicle control unit 3. In this way, the vehicle control system 1 can efficiently acquire the map data of the necessary area in the dynamic map based on driving route information containing a recommended driving lane. The first map server 4 can acquire the latest position data of the vehicle 2 from the vehicle control unit 3 (map positioning unit 32) and use the latest position data as the current position data of the vehicle 2.

Upon receiving the block data, the map positioning unit 32 acquires (expands) dynamic map data around the vehicle from the block data. Subsequently, the map positioning unit 32 (map coordination unit 54) performs a map coordination operation to provide the autonomous driving control unit 31 with a route in the high-precision map, the route corresponding to the route in the block data from the starting point (the current position of the vehicle 2) to the destination set by the mobile terminal 5.

The route in the navigation map set by the mobile terminal 5 includes lane information including the recommended driving lane. This enables the map coordination unit 54 in the map coordination operation to easily associate a lane(s) on the route in the navigation map with a corresponding lane in the route in the high-precision map (dynamic map). As a result, the processing load imposed on the vehicle control unit 3 during the map coordination operation is reduced compared to the case where a route in the navigation map without lane information is associated with a route in the high-precision map (which means that the vehicle control unit 3 needs to determine a new recommended driving lane).

After that, the autonomous driving control unit 31 (the action plan unit 41) creates a global action plan according to the route in the high-precision map.

Then, when a user operates the HMI 25 to instruct the vehicle to travel, the map positioning unit 32 identifies the position of the vehicle, and the autonomous driving control unit 31 sequentially creates a more detailed action plan based on the identified vehicle position, the position of an object(s) recognized by the external environment recognizing unit 30 and other information, and the travel control unit 42 controls the vehicle 2 to travel according to the created action plan.

When the vehicle 2 starts traveling, the probe information acquiring unit 33 starts to acquire probe information. While the vehicle is traveling, the probe information acquiring unit 33 transmits as appropriate the acquired probe information to the first map server 4 as probe information during autonomous driving. Upon receiving the probe information during autonomous driving, the first map server 4 stores the probe information as probe information during autonomous driving, and updates the dynamic map as appropriate based on the probe information during autonomous driving.

When the vehicle arrives at the destination, the autonomous driving control unit 31 performs a stop operation for stopping the vehicle, and a notification indicating that the vehicle has arrived at the destination is displayed on the HMI 25.

A user of the mobile terminal 5 does not necessarily have to be an occupant of the vehicle 2. In this case, the mobile terminal 5 can acquire in advance the position data of a destination and that of the vehicle 2 to perform the operation of generating the route, and transmit the generated route information to the vehicle control unit 3.

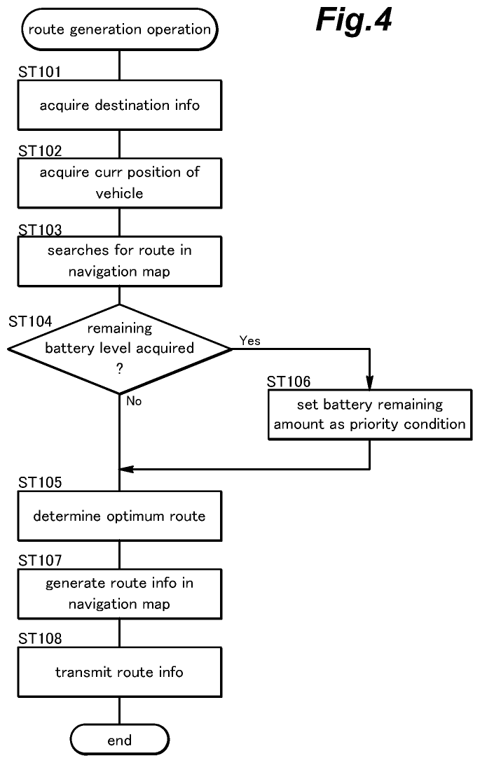

Next, details of the route generation operation performed by the mobile terminal 5 will be described with reference to FIG. 4. First, the mobile terminal 5 acquires destination information entered by a user (or an occupant) and the current position data of the vehicle 2 as appropriate (ST101, ST102).

Then, the mobile terminal 5 searches for a route on which the vehicle 2 can travel in the navigation map based on the destination information and the current position data of the vehicle 2 (ST103). In searching for the route, a known route search technique is used.

The route searched by the mobile terminal 5 includes additional recommended lane information about a recommended driving lane for each road section. The recommended driving lane information includes a priority level or priority order of each lane in a road section. The recommended lane information may include information on only one lane in each road section selected from multiple lanes as the lane in which the vehicle should travel.

For example, the mobile terminal 5 can determine a recommended driving lane selected from multiple lanes in each road section based on information records such as (i) a point(s) where the vehicle 2 needs to turn right or left, (ii) the types of lanes around an intersection through which the vehicle 2 is to pass (for example, whether or not there is a right-turn or left-turn lane), (iii) a speed limit and an average vehicle speed of each road section, (iv) information records of congestion in each lane (e.g., occupancy rate and traffic volume), and (v) the locations of an entrance and an exit of a toll road. When a road section includes only one lane, that lane is determined as a recommended driving lane.

In the route search operation in step ST103, the mobile terminal 5 can calculate the arrival time (the time when the vehicle 2 arrive at the destination) based on information such as the travel distance of vehicle 2 of each route, the estimated vehicle speed in each section, and the date and time (day of the week, time zone). The arrival time information is added to the route information generated later as necessary. As a result, the vehicle control unit 3 can easily acquire the arrival time at the destination from the mobile terminal 5.

Subsequently, the mobile terminal 5 determines whether or not it has acquired remaining battery level data of the battery for an electric motor of the vehicle 2 from the vehicle control unit 3 (ST104). When not having acquired remaining battery level data (No), the mobile terminal 5 determines one optimum route based on the route selection conditions preset by a user (such as conditions selected from the shortest time, the shortest distance, the minimum fuel consumption, and a system's recommended condition) (ST105).

When having acquired the remaining battery level data (Yes in ST104), the mobile terminal 5 sets the battery remaining amount as a priority condition for the route determination (ST106), and determines the optimum route based on this priority condition (ST105). In this case, for example, when the route selection condition set by the user is the “shortest time”, the mobile terminal 5 determines the shortest route within the range where the vehicle 2 can reach the destination with the current battery remaining amount.

In step ST104, the mobile terminal 5 may determine whether or not it has acquired remaining fuel level data, instead of or in addition to the remaining battery level data. In this case, in step ST105, the mobile terminal 5 sets at least one of the remaining battery level and the remaining fuel level as a priority condition for route determination. In this way, the mobile terminal 5 can set a more appropriate route according to the battery remaining amount and/or the fuel remaining amount used for traveling the vehicle 2.

Then, the mobile terminal 5 generates route information generated by adding the route information to the navigation map data (ST107). Moreover, the mobile terminal 5 transmits the route information to the vehicle control unit 3 (ST108).

In this way, the vehicle control system 1 is configured to receive data of a navigation map (i.e., a general-purpose map) from the second map server 6, thereby enabling the improvement of real-time property for updating the navigation map. The vehicle control system 1 also can generate, based on such navigation map data, driving route information including recommended lane information about a recommended driving lane. As a result, it is possible to reduce the processing load imposed on the vehicle control unit 3 during the map coordination operation.

The mobile terminal 5 can update the driving route information by repeatedly performing the route generation operation until the vehicle 2 reaches the destination. In this case, as the current position data of the vehicle 2 acquired in step ST102 is based on the latest position in the lane in which the vehicle 2 is traveling, the mobile terminal 5 can generate a more proper route.

Moreover, the vehicle control system 1 can effectively utilize the navigation map (that is, a general-purpose map) with a relatively small amount of information (i.e., amount of data) and a travel control map with a relatively large amount of information (that is, a high-precision map) for route navigation and travel control, respectively.

The present invention has been described in terms of specific embodiments, but is not limited by such embodiments, and can be modified in various ways without departing from the scope of the present invention. For example, the vehicle 2 may be equipped with a known in-vehicle navigation device. In this case, the mobile terminal 5 may be configured to perform a processing operation of substituting at least a part of the functions of the in-vehicle navigation device.

### Glossary

1 vehicle control system
2 vehicle
3 vehicle control unit
4 first map server
5 mobile terminal
6 second map server
11 powertrain
13 brake device
15 steering device
17 external environment sensor
19 vehicle sensor
21 communication device
23 GNSS receiving unit
30 external environment recognizing unit
31 autonomous driving control unit
32 map positioning unit
33 probe information acquiring unit
41 action plan unit
42 travel control unit
43 mode setting unit
51 map acquiring unit
52 map storage unit
53 vehicle positioning unit
54 map coordination unit
61 dynamic map storage unit
62 block data transmitting unit
63 probe information management unit
64 probe information storage unit
67 general-purpose map storage unit
71 communication unit
72 control unit
73 storage unit
74 input unit
81 map acquiring unit
82 vehicle coordination unit
86 navigation map data
87 vehicle coordination application

1. A vehicle control method for controlling a vehicle based on map information during autonomous driving of the vehicle, the method being performed by a vehicle control system, wherein the vehicle control system comprises:
a vehicle control unit mounted in the vehicle, wherein the vehicle control unit is configured to acquire travel control map data from a first map server, the travel control map data being data of a travel control map used for travel control, and perform the travel control of the vehicle based on the travel control map; and
a mobile terminal communicatively connected to the vehicle control unit, wherein the mobile terminal is configured to acquire navigation map data from a second map server, the navigation map data being data of a navigation map for route navigation, and provide the vehicle control unit with driving route information on a driving route in the navigation map,
wherein the navigation map contains lane information on a lane(s) forming each road section,
wherein the vehicle control unit is configured to transmit position data of the vehicle to the mobile terminal, and
wherein the mobile terminal is configured to:
based on the lane information and the position data of the vehicle received from the vehicle control unit, generate the driving route information including recommended lane information about a recommended driving lane which should be selected on a priority basis as a driving lane for the vehicle; and
transmit the driving route information including the recommended lane information to vehicle control unit.

2. The method according to claim 1, wherein the mobile terminal is configured to:
sequentially receive the multiple position data of the traveling vehicle from the vehicle control unit;
update the driving route information including the recommended lane information based on the latest position data of the vehicle; and
transmit the updated driving route information to the vehicle control unit.

3. The method according to claim 1, wherein the travel control map data includes dynamically changeable information which is not included in the navigation map data and can change with time in a more dynamic manner than that included in the navigation map data, and
wherein the dynamically changeable information includes at least one type of information selected from signal information, nearby vehicle information, and pedestrian information.

4. The method according to claim 1, wherein the vehicle control unit is configured to request the first map server to transmit the travel control map data based on the driving route information including the recommended lane information.

5. The method according to claim 1, wherein the mobile terminal is configured to calculate an estimated arrival time when the vehicle will arrive at an end point of the driving route based on the driving route information including the recommended lane information, and transmit the estimated arrival time to the vehicle control unit.

6. The method according to claim 1, wherein the mobile terminal is configured to acquire sensor measurement data from the vehicle control unit, the sensor measurement data being acquired by a sensor for measuring a remaining amount of battery or fuel used for driving of the vehicle, and
determine the driving route based on the sensor measurement data.

7. A vehicle control system for controlling a vehicle based on map information during autonomous driving of the vehicle, the system comprising:
a vehicle control unit mounted in the vehicle, wherein the vehicle control unit is configured to acquire travel control map data from a first map server, the travel control map data being data of a travel control map used for travel control, and perform the travel control of the vehicle based on the travel control map; and
a mobile terminal communicatively connected to the vehicle control unit, wherein the mobile terminal is configured to acquire navigation map data from a second map server, the navigation map data being data of a navigation map for route navigation, and provide the vehicle control unit with driving route information on a driving route in the navigation map,
wherein the navigation map contains lane information on a lane(s) forming each road section,
wherein the vehicle control unit is configured to transmit position data of the vehicle to the mobile terminal, and
wherein the mobile terminal is configured to:
based on the road information and the position data of the vehicle received from the vehicle control unit, generate the driving route information including recommended lane information about a recommended driving lane which should be selected on a priority basis as a driving lane for the vehicle; and
transmit the driving route information including the recommended lane information to vehicle control unit.
